(19) United States
(12) Patent Application Publication
(10) Pub. No.: US 2017/0277389 A1
(43) Pub. Date: Sep. 28, 2017

(54) PROCESS OF GENERATION OF A THREE-DIMENSIONAL GRAPHICAL REPRESENTATION OF A GEOGRAPHICAL ENVIRONMENT FROM POSITIONING DATA

(71) Applicant: BKOOL, S.L., Madrid (ES)

(72) Inventors: Nestor Matas Rodriguez, Madrid (ES); Ignacio Miguel Martinez Rodriguez, Madrid (ES); Pedro Maria Tabernero Sevilla, Madrid (ES)

(21) Appl. No.: 15/504,081

(22) PCT Filed: Aug. 19, 2015
(86) PCT No.: PCT/EP2015/069004

§ 371 Date: Feb. 15, 2017

Related U.S. Application Data
(60) Provisional application No. 62/039,594, filed on Aug. 20, 2014.
(60) Provisional application No. 62/113,071, filed on Feb. 6, 2015.

(51) Int. Cl. G06F 3/0481; G06T 17/05

(52) U.S. Cl. CPC G06F 3/04815; G06T 17/05; A63B 24/00

(57) ABSTRACT

Process of generating a three-dimensional graphical representation of a geographical environment from positioning data provided by a user, said process comprising the following steps: receiving positioning data corresponding to a geographical environment, said data defining the limits of said geographical environment; normalizing said positioning data with respect to an altimetry database; defining the area of three-dimensional graphical representation to be generated from said positioning data; obtaining information of the three-dimensional graphical representation to be generated from an altimetry database; a landcover database; a vegetation database; a road database; and an image database; and graphically representing the information obtained to generate the three-dimensional graphical representation.

### BACKGROUND

1. Field of the Invention

The present invention relates, principally, to the technical field of topography. More specifically, to the digital reconstruction of a real geographical environment or surroundings.

2. Description of the Related Art

The digital reconstruction of real geographical environments or surroundings is a technical field which has made a recent appearance, and is developing rapidly whilst progressively increasing not only in economic importance, but also in the number of its potential applications.

Said three-dimensional (3D) graphical representations or reconstructions of real geographical environments or surroundings find utility in, for example, planning and architectural design applications and/or public works, military applications, simulators (driving simulators, flight simulators . . . ) and indoor (or interior) sports training devices.

Some of the aforementioned indoor sports training devices emulate the experience of carrying out the training in a three-dimensional virtual scenario (or stage) in order that the exercise does not become repetitive or monotonous.

Said training devices mechanically recreate the conditions of a three-dimensional virtual scenario through which the user may move: thus, for example, indoor sports training devices which are attachable to a bicycle (or indoor bicycle) exist wherein the devices are supplied with a means of variable resistance which opposes pedaling with a higher or lower degree of resistance as a function of the slope of the location in the virtual scenario at which the user finds themselves. In addition, some of said devices show the user a graphical three-dimensional representation of said scenario via a screen.

Moreover, some of said indoor sports training devices allow the simultaneous practice of sport by multiple users.

The three-dimensional scenarios (or graphical representations) currently available for use as indoor training devices are fixed (or locked), pre-built scenarios, which are distributed via DVD.

In view of the foregoing, it would be interesting to develop a process of automatic generation of three-dimensional graphical representations of real geographical environments from positioning data provided by a user.

Said process would therefore permit the creation of different, infinite, three-dimensional graphical representations, each of which would correspond to a real geographical environment.

Furthermore, it would be especially preferred that the three-dimensional graphical representations created by this process could be used in indoor sports training devices and that said three-dimensional graphical representations may also be simultaneously accessible to multiple users.

In the present description, the following terms are defined as follows:
i. Database: databank that comprises a set of data that is used to process and generate the three-dimensional scenarios
ii. Bounding Box: determines the quadrilateral should be converted to 3D for a given route.
iii. Map: a container of tiles, each GPS route processed to 3D results in a map.
iv. Tile: “tile” of terrain or land. Formed by reconstructors.
v. Generic tile of high detail: contains the elements in high detail (those close to the user's view at all times, where a higher level of accuracy is required).
vi. Generic tile of low detail: contains the elements in low detail (those distant from the user's view at all times, where a lower level of precision is required).
vii. Layer: In presentation mode these are the different elements that appear on the screen (vegetation, roads, elevation, points of interest, etc.)
viii. Reconstructor: element resulting from the three-dimensional processing, included in a tile, which allows display of a layer in execution mode.

### SUMMARY

A first aspect of the invention relates to a process that generates a three-dimensional graphical representation of a real geographical environment from positioning data corresponding to said geographical environment, wherein said graphical representation includes the main topographic features (orography and elevation, etc.) corresponding to said geographical environment, as well as:

vegetation;

bodies of water (rivers, lakes, seas, etc.);

rocks; and

man-made constructions (features created by human intervention on the natural environment such as roads, paths, signage, buildings, etc.),

which are present in said geographical environment or surroundings.

Therefore, the process of the invention is capable of generating a three-dimensional graphical representation of anywhere on planet Earth from positioning data, for example, GPS route data. Three-dimensional graphical representations of another planet may be obtained with adequate positioning and environmental data.

The process according to the invention is therefore able to generate three-dimensional graphical representations of:

any surface on planet Earth selected by the user and/or

any route on planet Earth selected by the user,

In order to generate the three-dimensional graphical representation of said geographical environment, the process of the invention uses, among other information, at least one of the following:

information from at least one orographic and/or topographic database;

information from at least one altimetry (elevation) database;

information from at least one image database e.g. a satellite image database;

at least one database of virtual elements of specific use; and/or at least one virtual element of specific use designed for this purpose.

More particularly, the first aspect of the invention provides a process of generating a three-dimensional graphical representation of a geographical environment from positioning data supplied by a user, characterized in that it comprises at least the following steps:
a) receiving positioning data, for example GPS coordinates, corresponding to a geographical environment, the limits of said geographical environment defining said data;
b) normalizing said positioning data with respect to an altimetry database;
c) defining the area of three-dimensional graphical representation to be generated from said positioning data;
d) obtaining information corresponding to the area of the three-dimensional graphical representation to be generated, from at least one of the following databases:
   i) an altimetry (elevation) database;
   ii) a ground-cover database;
   iii) a vegetation database,
   iv) a road database; and
   v) an image database; and
e) graphically representing the information obtained in the previous step in order to generate the three-dimensional graphical representation of the geographical environment.

The process of generating according to the invention may additionally comprise a further step of storing the three-dimensional graphical representation of the geographical environment in a suitable format in order to be shown later on a display device. Examples of a suitable format include 3D vector formats such as X3D, Asymptote, IGES, .blend, JT, AMF, COLLADA, .dwf, .dwg, .dxf, eDrawings, .flt, HSF, IMML, IPA, OpenGEX, PRC, STEP, SKP, STL, U3D, VRML, XAML, XGL, XVL, xVRML, .3D, .3DF, .3DM, .3ds and 3DXML.

Thus, the three-dimensional graphical representation is preferably a three-dimensional model or three-dimensional representation of geometric data which represents the geographical environment. When displayed on a display device, said three-dimensional graphical representation is preferably displayed as a two-dimensional image or a stereoscopic image in order to provide an illusion of depth of field.

In addition, in a preferred embodiment, the process of the invention additionally comprises a step of optimizing the information obtained from said databases in step d) prior to graphically representing said information in step e). Said step of optimizing the information preferably comprises improving the capacity to generate the three-dimensional graphical representation of the geographical environment. Improving the capacity to generate the three-dimensional graphical representation preferably involves optimizing the data structures, response times, and the management of these variables. Alternatively, improving the capacity to generate the three-dimensional graphical representation preferably involves optimizing the degree of detail of the three-dimensional graphical representation and optimizing the speed of generation and retrieval of the three-dimensional graphical representation. The step of optimizing preferably comprises the use of configuration files.

In the present invention, the altimetry database is an elevation database, more preferably a hypsometry and/or bathymetry database. In addition, the ground-cover database comprises information on the type or types of terrain in the geographical environment. The vegetation database comprises information on the type or types of plants (or lack thereof) in the geographical environment. The road database is a database which comprises information on at least one of roads, streets, highways, motorways, freeways, alleys, ways, trails, tracks and/or paths. Examples of road databases include Google Maps, TeleAtlas Maps, and Matt Maps. In a preferred embodiment of the present invention, the image database is a satellite image database (such as GoogleEarth) or a terrestrial image database (such as Google Street View), more preferably a satellite image database. In addition to the aforementioned databases, the databases may also include extra information on elevation (heights), bodies of water, land-cover, points of interest, towns and cities, trees, man-made objects such as buildings, dams, bridges, electricity cables and rail networks (represented in 3D models as props), roads and details (such as type of geology, plant density, plant size), as outlined below.

The process of the invention also optionally takes into account that the three-dimensional graphical representation of the virtual geographical environment can be optionally generated with different levels of accuracy (or adjustment to reality). The level of adjustment is defined as a level of accuracy (precision or fidelity) in the virtual reproduction of the natural geographic environment or surroundings, depending, for example, on the device on which it will later be shown and its processing capacity (personal computer, mobile phone, tablet, etc.). The level of adjustment can practically reach 100%.

The three-dimensional graphical representations which are generated are suitable for visualization by the user in different ways:
any device with a screen in two dimensions (i.e. a flat screen): personal computers, tablets, mobile phones, television sets or others.
virtual screens.
holographic screens.
frontal visualisation screens (HUD HeadUpDisplay or Heads-Up Display).
virtual reality helmets (HMD—HeadMountedDisplay).

The process according to the invention may additionally comprise the processing and storage (saving) of the three-dimensional graphical representations in a cloud computing facility (the cloud) and/or a local computer or local computer network.

In a preferred embodiment of the invention, the process additionally comprises the following steps:
f) obtaining the universal time from a universal clock source;
g) using the positioning data received in step a) and the universal time received in step f), to obtain atmospheric information corresponding to the area of the three-dimensional graphical representation defined in step c), said atmospheric information being obtained from at least one of the following databases:
i) a temperature database;
ii) a ambient humidity database;
iii) a atmospheric pressure database;
iv) a wind database;
v) a rainfall database; and
vi) a cloud cover database.
h) estimating the weather condition of the area of the three-dimensional graphical representation defined in step c), at the universal time obtained in f), from the atmospheric information of step g);
i) graphically representing the weather condition of step h) in the three-dimensional graphical representation of step e).

In a more preferred embodiment of the invention, the process additionally comprises the following steps:
j) calculating the local time, corresponding to the area of the three-dimensional graphical representation defined in step c), from the universal time obtained in step f) and the positioning data received in step a);
k) using the positioning data received in step a) and the local time of j), to obtain sky/firmament information corresponding to the area of the three-dimensional graphical representation defined in step c), said sky/firmament information being obtained from at least one of the following databases:
   i) a sky illumination database;
   ii) a Mie dispersion database;
   iii) a Rayleigh dispersion database;
   iv) a Sun position database;
   v) a Moon position database;
   vi) a Moon phase database.
l) estimating the sky/firmament condition of the area of the three-dimensional graphical representation defined in step c), at the local time obtained in j), from the sky/firmament information of step k);
m) graphically representing the sky/firmament condition of step l) in the three-dimensional graphical representation of step e).

The temperature database used in the context of the present invention, provides the temperature value corresponding to a given position at a certain universal time. The ambient humidity database provides the ambient humidity value corresponding to a given position at a certain universal time. In addition, the sky illumination database provides the information regarding the sky illumination of a given position at a certain universal local time. Similar criteria apply to the remaining databases.

Furthermore, the process according to the invention is preferably associated with an indoor sports training device and can transmit three-dimensional graphical representation of the virtual geographical environment via the Internet network (via a cable or wireless means) to a local computer or local computer network, which is used by the indoor sports training device.

In this embodiment of the invention which can optionally also represent each user within the three-dimensional graphical representation generated using an individual avatar, with different possible levels of personalization. The representation includes a system of displacement corresponding to that which the user is utilizing (autonomous or machine).

In this way it is possible to represent the real-time positioning on or over the generated three-dimensional graphical representation of from one or more and up to more than 100 users moving on a defined route in the generated outdoor virtual environment.

One of the advantages of this embodiment of the process according to the invention is the possibility for the three-dimensional graphical representations, thus generated, to be distributed on demand, i.e. the user should not store information on his/her device but instead this is distributed through a system of streaming, as required by the user, via a predictive system.

The displacement of each user may correspond to the use of different indoor physical exercise machines. In addition, the degree of effort required to displace said user through any given virtual scenario while using said indoor physical exercise machines may be changed to correspond to changes in said virtual scenario, such as the slope and/or type of the virtual terrain.

A second aspect of the invention relates to a device for use of the process of generating three dimensional graphical representations of geographical environments, as described herein.

In addition, said device according to the second aspect of the invention may comprise programmable logic means which are optionally comprised in or connected with (via a cable or wireless means) an indoor sports training device, and optionally include the following features:

i. Multiplatform support: all the functionality of the process according to the invention is supported by any PC platform [preferably operating with a Windows, Mac (OS X) or Unix and Unix-like operating systems (including System V, BSD, QNX, HP-UX, AIX, Solaris, Google Chromium OS, GNU and Linux or Linux-based) operating system], tablets [preferably operating with an iOS, Android, Blackberry, Windows Phone, Symbian or Opensource (including Tizen, Firefox OS, Ubuntu Touch OS or Sailfish OS) mobile operating system] mobile phones [preferably operating with an iOS, Android, Blackberry, Windows Phone, Symbian or Opensource (including Tizen, Firefox OS, Ubuntu Touch OS or Sailfish OS) mobile operating system], with the only limitation to the physical processing capacity of these machines.
ii. 3D Velodrome: As in the case of 3D World, sessions can be performed within 3D velodromes on the part of the user.
iii. Music: allows the inclusion of music in real time during the practice of physical activity. Music is managed by the user directly from the Internet platform Spotify.
iv. Voice Chat: voice chats can be made with the remaining users within the same multiplayer games.

The device according to the second aspect of the invention optionally comprises a positioning data-receiving set and a device for generating three-dimensional graphical representations of geographical environments (which is also referred to herein as a “3D terrain generator”).

### BRIEF DESCRIPTION OF THE DRAWINGS

FIG. 1 is a schematic diagram showing an embodiment of a device according to the present invention, wherein said device employs a web environment.

FIG. 2 is a flowchart generically illustrating the main steps comprised in an embodiment of the process according to the present invention.

FIG. 3 is a flow chart showing the steps of defining the area, obtaining and homogenizing information and three-dimensional graphical representation, according to said embodiment of the process according to the present invention.

FIG. 4 is a flow chart showing the step of generating the three-dimensional graphical representation, according to said embodiment of the present invention.

FIG. 5 is a flow chart showing the steps of estimating and graphically representing the weather condition, according to said embodiment of the present invention.

### DETAILED DESCRIPTION

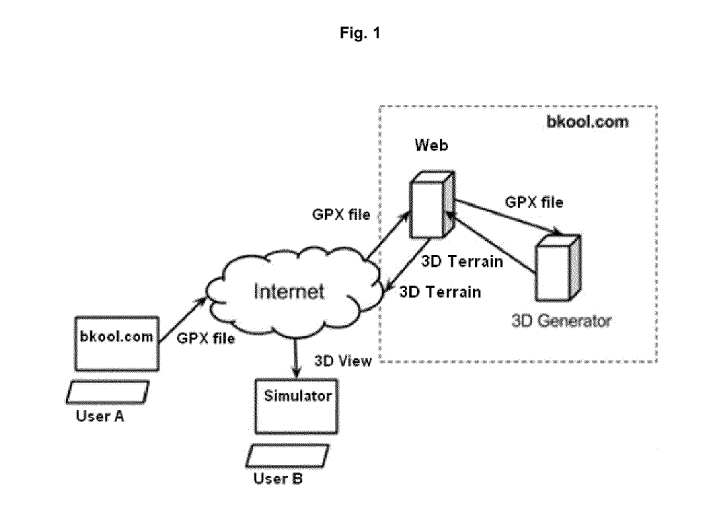

FIG. 1 shows an embodiment of a device according to the present invention which employs a web environment and is associated with an indoor sports training device, which provides service to two or more users.

In this embodiment, a user “User A” loads onto a website or network (comprised in the positioning data-receiving set) or via a mobile device application (which is also optionally comprised in the positioning data-receiving set), a GPS positioning data file “GPX file”.

The website or network receives the file and the positioning data-receiving set validates the file and sends it to the 3D terrain generator.

The 3D terrain generator processes the GPS positioning data file and makes the generated three-dimensional graphical representation available to all users of the sports training device.

In the event that a user wishes to use the three-dimensional graphical representation which has been generated in order to undertake a previously generated 3D virtual route on the sports training device:
1. The route is selected in a simulator that comprises a sports training device.
2. The route is executed [run] and the 3D itinerary is displayed with avatars.
3. All 3D information is sent to the user based on their needs at each moment of execution.

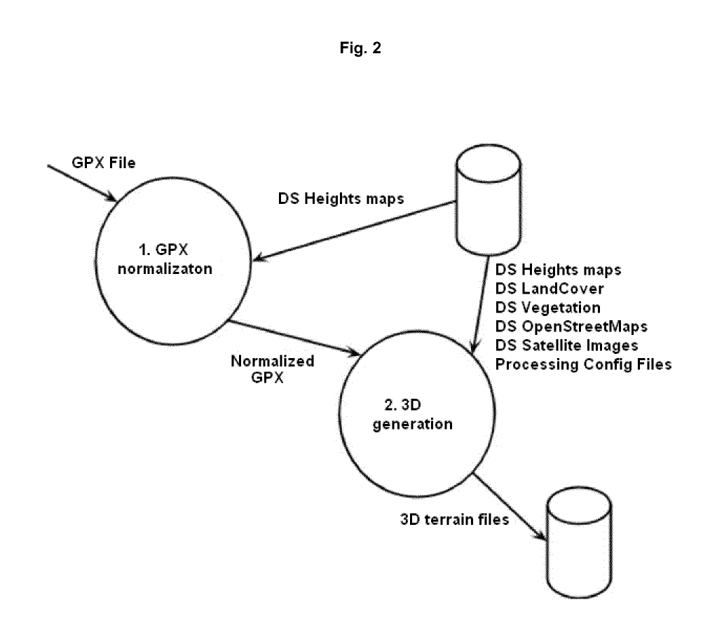

FIG. 2 shows the process of generating the three-dimensional graphical representations of geographic environments (which are also referred to herein as “the 3D terrains”) within the 3D generator:
1. The GPS positioning data file “GPX File” is received.
2. Normalization of the data is performed with reference to the altimetry database “Heights maps DS”
3. The normalized GPS data passes to step of graphically representing the information “2. 3D Generation”
4. 3D terrain generation is performed using the information from the following databases: altimetry database “DS Heights maps”, ground-cover database “DS LandCover”, vegetation database “DS Vegetation”, road database “DS OpenStreetMaps”, satellite image database “DS Satellite Images”; and the information obtained from said databases is homogenized through use of “Processing Config Files”.
5. The three-dimensional graphical representations or 3D scenarios “3D terrain files” are generated and stored (e.g. on a disc).

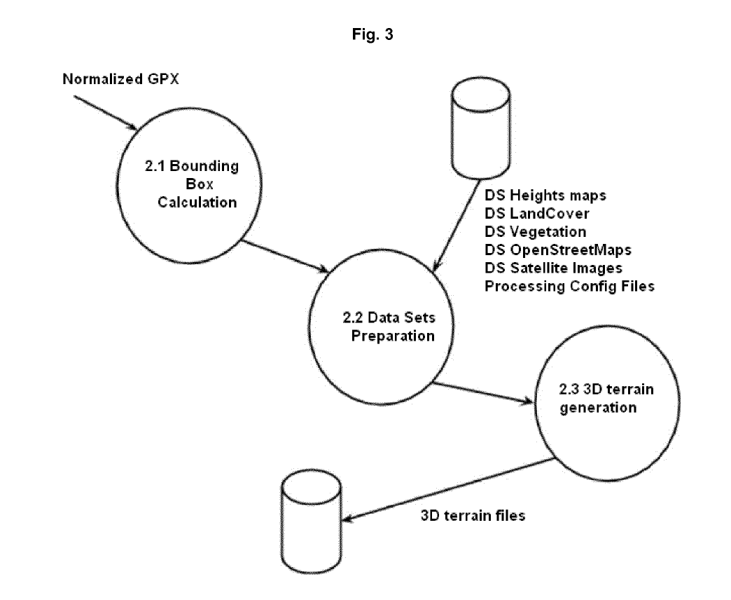

FIG. 3 shows a first level of detail with the steps of defining the area, obtaining and homogenizing the information, and three-dimensional graphical representation, according to an embodiment of the process according to the present invention.

As shown in said figure, the steps of the process are as follows:
1. The area (“Bounding Box”) which should be generated in 3D is calculated in the process “2.1 Bounding Box Calculation”.
2. All information pertaining to that area of the databases corresponding to the process “Data Sets 2.2 Preparation” is obtained.
3. The process of generating the three-dimensional graphical representation is performed in the process “2.3 3D terrain generation”.
4. The three-dimensional graphical representation (3D terrain) is stored in order to serve users on demand.
   We now detail the process “2.3 3D terrain generation”.

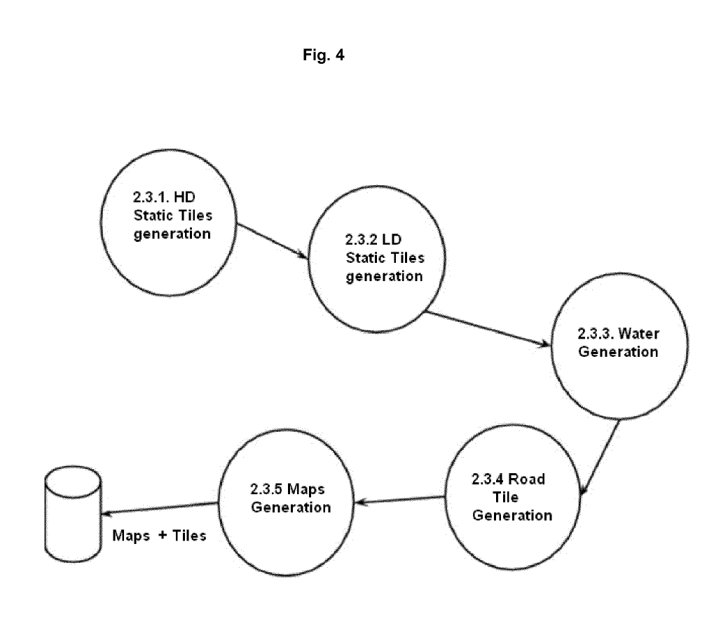

The step of generating the three-dimensional graphical representation, according to said embodiment of the present invention, is shown in FIG. 4 and, in this embodiment of the invention, comprises the following processes (or sub-stages):
1. Tiles (or portions in which the area of the three-dimensional graphical representation to be generated are divided) are created in high detail in the process “2.3.1. HD Static Tiles generation”. Each of these high detail tiles comprises two or more layers. Each layer comprises, in turn, one of the different elements present in the three-dimensional graphical representation (vegetation, roads, heights, details, points of interest, etc.). In this process the data from the different layers (except the road layer and the detail layer) are generated and encapsulated in reconstructors.
2. Low detail tiles are created in the process “2.3.2. LD Static Tiles generation”. This process is carried out starting from the tiles resulting from the previous process, simplifying their contents.
3. The structures (meshes) of water from rivers and lakes are created in the process “2.3.3 Water generation”.
4. Within the “Bounding Box” and the set of tiles that define it, it is determined that Tiles contain segments of road, and the road tiles are adjusted in the process “Road Tile 2.3.4 Generation” with the specific data of the road.
5. The three-dimensional graphical representation indicating the set of tiles that define the “Bounding Box” generated within the process “Maps 2.3.5 Generation” is created. All files corresponding to the three-dimensional graphical representation are stored for later use in a simulator.

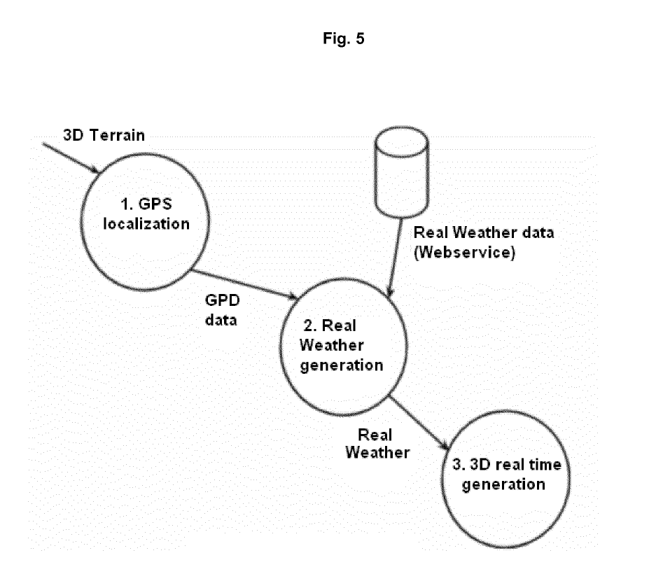

FIG. 5 shows the process of generating the three-dimensional graphical representations
1. The GPS positioning data file “GPS data” is received.
2. The weather condition for the 3D terrain, corresponding to said GPS data at the universal time, is estimated with reference to the atmospheric information database “Real Weather data (webservice)”
3. The estimated weather condition is graphically represented and incorporated into the three dimensional graphical representation of the geographical environment.

In this embodiment of the invention all the databases have passed a process of optimization to improve the capacity of automatic generation of the 3D terrains. The databases used are as follows and from the following sources, although other sources of data from other databases or databanks which comprise similar data (orographic, vegetation, streets (for example Google Maps), types of terrain, images obtained from different sources (for example, Google Street View) may be used:
Altimetry (elevation) database: DS Heights maps: ASTER GDEM V2 (http://asterweb.jpl.nasa.gov/gdem.asp)
Landcover database: DS landCover: http://due.esrin.esa.int/globcover/
Vegetation database: DS Vegetation: http://www.iscgm.org/gm/ptc.html
Road database: DS OpenStreetMaps: In one embodiment, information concerning the positioning and dimensions of rivers, lakes, roads, main streets, city and mountain peaks is obtained from here. More features may be obtained therefrom in the future such as the coastline.
Satellite image database: DS Satellite Images: In one embodiment this is obtained from GoogleMaps.

Moreover, in this embodiment the homogenization of the information obtained from said databases is carried out through use of some files “Processing Config Files”: which are themselves configuration files by layer.

Obviously, these databases and their use are designed to be replaced by other equivalents or to improve the precision of processing in future implementations.

Moreover, the present embodiment of the invention uses the following layers [wherein a description of each layer, examples of databases from which the data for each layer is derivable from, and whether each layer is configurable or not (i.e. whether the behaviour of the layer may be configured depending on the purpose it will have: e.g. it may be that it is desired to subsequently use a given layer in at least one different device such as a mobile phone, tablet or PC, and this implies configuring said layer in different ways in each device in the moment of generating the three-dimensional graphical representation of the geographical environment) is provided]:

a) Elevation (heights):
Description: Generates the elevation (height) map of each tile from the altimetry database (DS Heights maps) with the resolution and size of tile that the configuration file indicates to us. In addition, some noise is included in the heights to simulate the erosion by air and water, and to give the field a more natural look. The parameters of this noise also appear in the configuration file
Databases: DS Heights maps
Configurable: Yes

### b) Water

Description: Pierces the terrain [earth] in conformity with the configuration file parameters (water depth, shore-smoothing parameters, etc.), and generates files of meshes of lakes and rivers for example.
Databases: DS OpenStreetMaps
Configurable: Yes
   c) Land cover
Description: Adjusts the texture of the ground of each tile from the information that the corresponding databases give us. For each type of terrain the configuration file indicates what textures should be used for each range of slope in the terrain [land]; in addition, also the range of parameters required to make the analysis of satellite images.
Databases: DS LandCover and DS Satellite Images
Configurable: Yes

### d) Points of Interest

Description: Saves in each tile the points of interest contained therein.
Databases: DS OpenStreetMaps
Configurable: Yes
   e) Streets and cities
Description: Secondary streets are generated from the roads [highways] and main streets, as is the location of where the buildings are. For each tile the list of buildings that it contains and should show at the time of execution of the simulator is saved. The configuration file indicates the own parameters of the algorithm for generation of streets and buildings.
Databases: DS OpenStreetMaps
Configurable: Yes

### f) Props

Description: The configuration file indicates which props (3D models of man-made objects) have to be placed in each type of terrain. The props are placed randomly in conformity with a probability designated in the configuration.
Databases: DS LandCover
Configurable: Yes

### g) Trees

Description: Plants trees in each tile. A series of trees with a given probability of occurrence is configured for each type of terrain. Each tree is planted in conformity with the satellite image, a texture of noise or a density of vegetation value read from the databases. The configuration file indicates under what conditions and with what method each tree must be planted.
Databases: DS Vegetation, DS LandCover and DS Satellite Images
Configurable: Yes

### h) Road

Description: Generates, from generic tiles, the specific tiles of each route, i.e. those tiles through which the road passes. In order to do this:
1. Soften the normalized GPX using the algorithm of lang and generate a spline of CatmullRom.
2. Flatten the ground and remove everything added by the layers of trees, props and buildings, as well as respect areas marked as water.
Databases: DS Heights maps
Configurable: Yes

### i) Details

Description: Place, in the specific tiles of each route, small details that will be visible near the road. Details are herbs or small stones. The configuration file indicates which types of herbs should be planted for every type of terrain and with what density.
Databases: DS LandCover
Configurable: Yes

1. A process of generating a three-dimensional graphical representation of a geographical environment from positioning data provided by a user, characterized in that said process comprises at least the following steps:
a) receiving positioning data corresponding to a geographical environment, said data defining the limits of said geographical environment;
b) normalizing said positioning data with respect to an altimetry database;
c) defining the area of three-dimensional graphical representation to be generated from said positioning data;
d) obtaining information corresponding to the area of the three-dimensional graphical representation to be generated from at least the following databases:
i) an altimetry database;
ii) a landcover database;
iii) a vegetation database;
iv) a road database; and
v) an image database; and
e) graphically representing the information obtained in the previous step in order to generate the three-dimensional graphical representation of the geographical environment.

2. The process of claim 1 comprising the further step of storing the three-dimensional graphical representation of the geographical environment in a suitable format in order to be shown later on a display device.

3. The process of claim 2, wherein the three-dimensional graphical representation is generated and/or stored on a cloud computing facility and/or a local computer or local computer network.

4. The process of claim 1, wherein in the step of graphically representing the information obtained as a three-dimensional graphical representation, the level of precision of said three-dimensional graphical representation may be adjusted.

5. The process of claim 1, further comprising sending the three-dimensional graphical representation to an indoor sports training device.

6. The process of claim 1, further comprising a step of optimizing the information obtained from said databases in step d) prior to graphically representing said information in step e).

7. The process of claim 1, further comprising the steps:
f) obtaining the universal time from a universal clock source;
g) using the positioning data received in step a) and the universal time received in step f), to obtain atmospheric information corresponding to the area of the three-dimensional graphical representation defined in step c), said atmospheric information being obtained from at least one of the following databases:
i) a temperature database;
ii) a ambient humidity database;
iii) a atmospheric pressure database;
iv) a wind database;
v) a rainfall database; and
vi) a cloud cover database;
h) estimating the weather condition of the area of the three-dimensional graphical representation defined in step c), at the universal time obtained in f), from the atmospheric information of step g);
i) graphically representing the weather condition of step h) in the three-dimensional graphical representation of step e).

8. The process of claim 7, also comprising the following steps:
j) calculating the local time, corresponding to the area of the three-dimensional graphical representation defined in step c), from the universal time obtained in step f) and the positioning data received in step a);
k) using the positioning data received in step a) and the local time of j), to obtain sky/firmament information corresponding to the area of the three-dimensional graphical representation defined in step c), said sky/firmament information being obtained from at least one of the following databases:
i) a sky illumination database;
ii) a Mie dispersion database;
iii) a Rayleigh dispersion database;
iv) a Sun position database;
v) a Moon position database;
vi) a Moon phase database.
l) estimating the sky/firmament condition of the area of the three-dimensional graphical representation defined in step c), at the local time obtained in j), from the sky/firmament information of step k);
m) graphically representing the sky/firmament condition of step l) in the three-dimensional graphical representation of step e).

9. A device for use of the process of claim 1.

10. The device of claim 9, further comprising programmable logic means.
